(19) United States
(12) Patent Application Publication
(10) Pub. No.: US 2023/0401563 A1
(43) Pub. Date: Dec. 14, 2023

(54) PROACTIVE VIRTUAL CARD PROVISIONING

(71) Applicant: Capital One Services, LLC, McLean, VA (US)

(72) Inventors: Mykhaylo Bulgakov, Arlington, VA (US); Andrea Montealegre, Arlinigton, VA (US); Abdelkader M'Hamed Benkreira, Washington, DC (US)

(21) Appl. No.: 17/839,562

(22) Filed: Jun. 14, 2022

(51) Int. Cl. G06Q 20/34; G06Q 20/42; G06Q 20/40

(52) U.S. Cl. CPC G06Q 20/351; G06Q 20/42; G06Q 20/405

(57) ABSTRACT

Virtual cards are proactively provisioned for online purchases. Merchant transactions or user browser actions can be analyzed for the existence of a trigger condition such as recurrent merchant transactions or registration on a merchant website, among other things. In response to detecting the trigger condition, a request is sent to a customer for permission to add a virtual card for payment of a merchant online. Subsequently, a request is submitted for the virtual card for the customer from a financial institution in response to permission being granted, where the virtual card is linked to an account of the customer at the financial institution. A browser script can next be executed that adds the virtual card as the primary payment method of a website of the merchant.

### BACKGROUND

Virtual cards are designed to reduce the risk of fraud online associated with identity theft. Virtual cards allow individuals to make payments online without exposing their regular credit or debit card number. Virtual cards can also provide users more control than traditional credit cards. For example, virtual card numbers can be immediately issued and revoked. Furthermore, an account holder can control when and how a virtual card is used. For instance, a virtual card can be configured to expire after a number of uses or a time limit or dollar amount has been reached. Additionally, a virtual card number can be limited to use associated with a particular merchant. Even if a fraudster obtains the virtual card number to make purchases, the account holder can be entitled to a chargeback as if the purchase were made with their regular card. However, the regular card and account number do not need to change, and a new virtual card can be issued promptly.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

Briefly described, the subject disclosure pertains to proactive provisioning of virtual cards. Customer actions can be analyzed to trigger the provisioning of a virtual card. For instance, customer transactions can be analyzed to identify recurrent transactions with a merchant, or an action associated with registering with a merchant website can be detected. Once triggered, a virtual card can be acquired from a financial institution server. The virtual card can be linked with a customer account at the financial institution and acquired through interaction with an application programming interface. A spending constraint can also be determined or inferred that seeks to balance security concerns associated with merchant interaction and customer preferences. The virtual card can be configured to include the spending constraint. Subsequently, the virtual card can be added as a payment method to the merchant website by triggering execution of a browser script that navigates to the payment location and replaces any current payment method with the virtual card.

According to one aspect, disclosed embodiments can include a virtual card provisioning system that comprises a processor coupled to a memory that includes instructions that, when executed by the processor, cause the processor to detect a recurrent transaction with a merchant by a customer online based on analysis of transaction history of the customer from a financial institution, request permission from a customer to provision a virtual card for payment of a merchant online through a web browser in response to detection of the recurrent transaction, and request the virtual card for the customer from the financial institution in response to receipt of granted permission, wherein the virtual card is linked to an account of the customer at the financial institution. Further, the instructions can cause the processor to locate a browser script associated with the merchant and initiate execution of the browser script that directs a customer to a login webpage of a merchant website and, after successful login, navigates to a payment webpage of the merchant website and automatically sets the virtual card as the primary payment method on the merchant website. During browser script execution, the instructions can further cause the processor to remove a prior customer payment method for the website. Further, the instructions can cause the processor to automatically infer a spending constraint that reduces likelihood of fraud based on context data considering the merchant and the customer and request the virtual card be configured with the spending constraint. A machine learning model can be invoked to infer the spending constraint automatically in one embodiment. The spending constraint can limit spending to transactions with the merchant in one instance. The instructions can also cause the processor to determine that the virtual card is invalid based on a spending constraint that specifies expiration after a predetermined time or number of transactions and request the permission in response to a determination that the virtual card is invalid.

In accordance with another aspect, disclosed embodiments can include a method comprising executing, on a processor, instructions that cause the processor to perform operations associated with provisioning a virtual card. The operations include detecting a recurrent transaction with an online merchant in transaction history of a customer recorded by a financial institution, soliciting permission from the customer to provision a virtual card for payment of an online merchant in response to the recurrent transaction, and requesting the virtual card for the customer from a financial institution in response to receipt of granted permission, wherein the virtual card is linked to an account of the customer at the financial institution. The operations can further comprise searching for a browser script associated with the online merchant and triggering execution of the browser script that adds the virtual card as the primary payment method for a website of the online merchant after successful customer login to the website. Furthermore, the operations can comprise removing a prior customer payment method for the website with the processor during browser script execution to remove a prior customer payment method for the website. The method can also include operations comprising inferring a virtual card constraint that reduces likelihood of fraud based on context data considering the merchant and the customer and requesting the virtual card be configured with the constraint. In one embodiment, inferring the constraint can further comprise executing a machine learning model to automatically infer the virtual card constraint. Further, the operations can comprise adding a virtual card with a predetermined constraint as the primary payment method. In one instance, the operations can comprise adding a virtual card limited to transactions with the online merchant as the predetermined constraint. In another instance, the operations further comprise adding a virtual card that expires after a predetermined time or number of transactions as the predetermined constraint.

According to yet another aspect, disclosed embodiments can include a computer-implemented method. The method can comprise soliciting permission from a customer to provision a virtual card for payment of a merchant in response to detecting a trigger condition, requesting the virtual card for the customer from a financial institution in response to receipt of granted permission, wherein the virtual card is linked to an account of the customer at the financial institution, locating a browser script associated with the merchant from amongst a set of browser scripts for multiple merchants, and triggering execution of a browser script that adds the virtual card as the primary payment method for a website of the merchant. The method can further comprise detecting, as the trigger condition, a recurrent transaction with a merchant by the customer from a transaction history of the customer and soliciting the permission for the merchant in response to detection of the recurrent transaction. Further, the method can comprise detecting, as the trigger condition, registration on the website of the merchant and soliciting the permission in response to detecting registration. The method can also include swapping a current primary payment method with the virtual card during browser script execution and directing the customer to a login page on the website of the merchant during browser script execution. Furthermore, the method can comprise inferring a virtual card constraint that reduces a likelihood of fraud based on merchant security data and customer preference and requesting the virtual card be configured with the constraint. In one instance, inferring the constraint further invokes a machine learning model to determine the constraint automatically.

To the accomplishment of the foregoing and related ends, certain illustrative aspects of the claimed subject matter are described herein in connection with the following description and the annexed drawings. These aspects indicate various ways in which the subject matter can be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates an overview of an example implementation.

FIG. 2 is a block diagram of a virtual card system.

FIG. 3 is a block diagram of an example acquisition component.

FIG. 4 is a flow chart diagram of a method of transitioning to a virtual card.

FIG. 5 is a flow chart diagram of a method of adding a virtual card to a merchant store.

FIG. 6 is a flow chart diagram of a method of adding a virtual card to an online merchant account.

FIG. 7 is a flow chart diagram of a method of updating a virtual card.

FIG. 8 is a flow chart diagram of a method of configuring spending constraints.

FIG. 9 is a block diagram illustrating a suitable operating environment for aspects of the subject disclosure.

### DETAILED DESCRIPTION

Details disclosed herein generally pertain to proactive virtual card provisioning. User actions can be monitored and utilized to trigger generation of a virtual card and addition of the virtual card as a payment method on a merchant website. User actions can correspond to prior purchases, merchant registration, or other triggering events. After a triggering event occurs, permission is solicited from a user or customer. If the customer grants permission, a virtual card is generated that is linked to an account of the user. Subsequently, a script is executed that automatically navigates a merchant site and adds the virtual card as the primary payment method. Accordingly, any previous payment method can be replaced or swapped with the virtual card. Employment of the virtual card mitigates fraud and leaking of sensitive information outside transactions. Further, updating a payment method for an online merchant proactively and automatically reduces customer friction and promotes virtual card usage.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Instead, the intention is to cover all modifications, equivalents, and alternatives falling within the spirit and scope of the claimed subject matter.

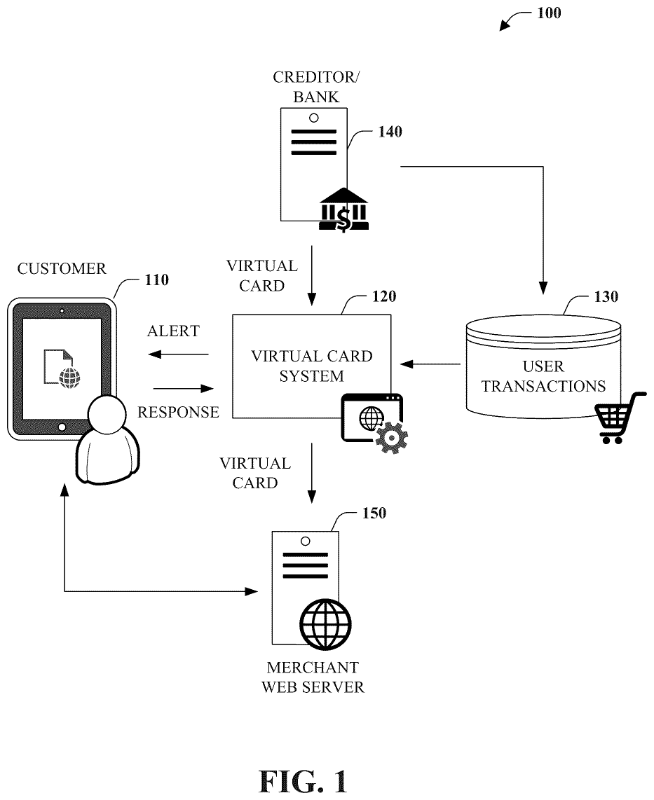

Referring initially to FIG. 1, a high-level overview of an example implementation 100 is depicted. As shown, the implementation includes customer computing device 110, virtual card system 120, user transactions 130, creditor server 140, and merchant web server 150.

The customer computing device 110 can correspond to any computing device (e.g., laptop, desktop, tablet, smartphone) a user or customer uses to access merchant websites. A customer can be a person who utilizes a financial institution's services to acquire and use a credit or debit card. The customer can employ a web browser to shop and transact with merchants online. For example, the customer computing device 110 can connect with the merchant web server 150, enabling the electronic purchase of goods or services. Typically, the customer uses a credit or debit card to make a purchase. For example, the customer can provide the credit card number, expiration date, and security code, along with the customer's name and address.

Suppose there is a security breach on the merchant side or a virus on the customer computing device 110. In those cases, the customer's credit or debit card information can be exposed and used by a fraudster to purchase other goods or services substantially anywhere. The customer would then need to contact the financial institution that issued the card to cancel the card and report the fraud. Typically, the financial institution orders a new card that is then sent to the customer by mail. The customer does not have access to their account during that time. The time can be several days, which is inconvenient, especially if the card is the customer's sole card for purchases.

The virtual card system 120 can be installed as an extension to the web browser of the customer computing device 110. In this embodiment, the virtual card system 120 can analyze user transactions 130. The user transactions 130 can correspond to purchases made with a conventional card issued by a financial institution or creditor. The analysis seeks to detect recurrent transactions with a merchant. For example, if the user transaction history indicates the user has transacted with a business multiple times, transactions can be deemed recurrent for that merchant. Detection of a merchant with which a customer has recurrent transactions can trigger further action by the virtual card system 120. The action can be termed proactive, resulting from a trigger instead of responding to a customer request.

The virtual card system 120 can alert or notify the customer in response to the trigger. The alert can comprise a recommendation or suggestion that the user swap a conventional credit or debit card with a virtual card. The recommendation can also recommend spending constraints. Examples of spending constraints include making the virtual card valid solely for recurring merchant purchases or setting spending limits. The customer can review the recommendation and accept or deny the recommendation. Further, the customer can also consent to or alter any suggested constraints. For example, a maximum spending limit can be increased or decreased, or the card's expiration date changed.

If the user consents to the virtual card swap, the virtual card system 120 can contact the creditor server 140 to request a virtual card or associated information. A virtual card is a virtualized or emulated version of a physical debit or credit card that includes at least a number and expiration date for use in making online or electronic purchases. The request can also include any spending constraints agreed to by the customer. The creditor server 140 issues the virtual card with the constraints. The creditor server 140 links the virtual card to the customer's account as part of card issuance. Once complete, the credit server 140 can provide the virtual card to the virtual card system 120.

The virtual card system 120 can locate a script associated with the merchant next. The script is a program or sequence of executable instructions that navigate a merchant's website to add the virtual card as a payment method. Once located, the virtual card system 120 can connect to the merchant web server 150 and trigger execution of the script. In one instance, a customer may need to provide login credentials to access the customer's account with the merchant. Otherwise, the change can be completely automatic. The script can remove the primary payment method and replace the payment method with the virtual card. In other words, the script can swap the payment method to the virtual card. The current payment method can be removed from the account or saved as a secondary means of payment.

The customer can subsequently interact with the merchant web server 150 as usual to make purchases. However, the virtual card can be utilized to pay for the purchases. Real account information or credit card information need not be exposed. Instead, solely virtual card information is provided. Further, if the virtual card is exposed to a fraudster, the card can only be utilized in accordance with constraints set for the virtual card. For example, the virtual card can be limited to purchases from a particular merchant and up to a certain amount. This can limit fraudulent purchases. Furthermore, if fraud is detected or reported, a new virtual card can be provided substantially immediately, limiting the impact on a customer's ability to make purchases. In one instance, the virtual card system 120 can be triggered to replace a current virtual card with a new virtual card.

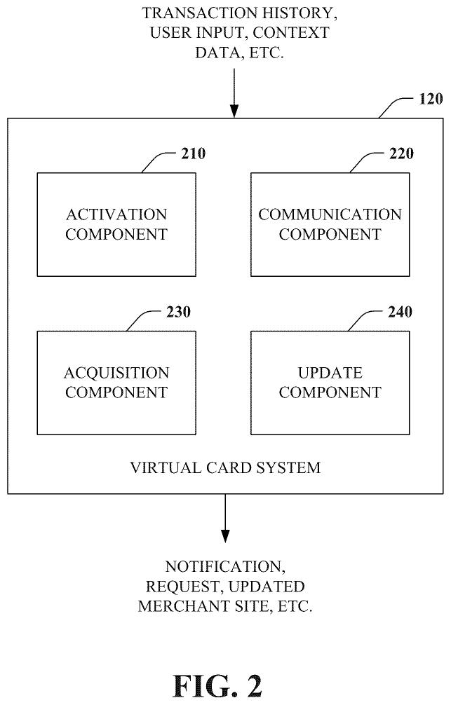

Turning attention to FIG. 2, an example virtual card system 120 is illustrated in further detail. The virtual card system 120 includes activation component 210, communication component 220, acquisition component 230, and update component 240. The virtual card system 120 is operable to automatically transition an online payment method to a virtual card or virtual credit card. The activation component 210, communication component 220, acquisition component 230, and update component 240 can be implemented by a processor coupled to a memory that stores instructions that, when executed, cause the processor to perform the functionality of each component. As such, a computing device is configured to be a special-purpose device that implements the functionality of the virtual card system 120.

The activation component 210 is operable to trigger virtual card transition. The activation component 210 is configured to monitor one or more conditions and trigger when a condition is satisfied. There can be one or more triggers. In one instance, the condition can concern detecting the occurrence of recurrent transactions with a merchant. Transaction history of the user can be analyzed to detect recurrent transactions. For example, a recurrent transaction can correspond to more than one user transaction with an online retailer. Of course, the recurrent transactions can be defined with more detail, such as two or more transactions within a predetermined time. Additionally, or alternatively, a recurrent transaction can correspond to a monthly subscription service. Essentially, any transaction pattern can be defined and employed as an activation condition.

In another instance, the condition can correspond to registration on a merchant website. Merchants typically encourage or require users to register before making purchases. Registration can involve providing name, address, phone number, and payment information. The activation component 210 monitors browser activity to detect a registration process. Subsequently, actions can be performed to add a virtual card as the payment method instead of a traditional credit or debit card. In this manner, a subsequent swap from conventional to virtual payment need not be performed.

In yet another instance, the condition can correspond to the expiration of a virtual card or other issues with using a virtual card for purchases. One feature of virtual cards is the ability to constrain purchases. These constraints can expire or reach levels such that a virtual card is no longer usable. The activation component 210 can monitor virtual card constraints and trigger the replacement of a virtual card. In one scenario, the card can be different such that a virtual card is swapped with a new card. Alternatively, the virtual card can be updated to enable usability while otherwise remaining unchanged. For example, a spending limit can be increased or an expiration date updated.

The communication component 220 is operable to communicate with a customer. The communication component 220 can notify a customer regarding a virtual card. In one instance, the communication component 220 can solicit permission from the customer to perform a virtual card swap. The communication component 220 can then receive a response from the customer, either granting or denying permission to perform the swap. The communication component 220 is also operable to recommend or suggest virtual card spending constraints. Further, a response can be received granting or denying permission alone or combined with requested alterations to the spending constraints. For example, a customer can request the spending limit be removed or the card made available for more than one merchant. Other communications can be enabled between the virtual card system 120 and the customer based on a particular triggering event.

The acquisition component 230 is operable to acquire a virtual card from a virtual card provider. For example, the acquisition component 230 can utilize an application programming interface (API) provided by a financial institution to request and receive a virtual card. The virtual card can comprise a number or token (e.g., card number, major industry identifier (MII), issuer identification number (IIN), account number) as well as a security code (e.g., card verification value (CVV), card verification code (CVC) or card identification number (CID)) and expiration date similar to conventional credit and debit cards. The acquisition component 230 is also operable to determine or infer spending constraints and request that the constraints be applied to the virtual card.

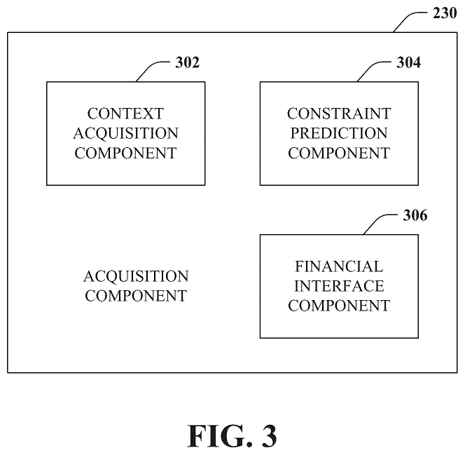

Turning attention briefly to FIG. 3, the acquisition component 230 is depicted in further example detail. The acquisition component 230 includes context acquisition component 302, constraint prediction component 304, and financial interface component 306.

The context acquisition component 302 is operable to receive, retrieve or otherwise obtain or acquire context data from one or more sources. The context data can concern a merchant, a customer, or both as well as other general context data. Merchant context data can pertain to the security and treatment of customer data. For example, the context data can indicate a number and extent of data breaches over a predetermined time as well as any information as to the data storage architecture. Customer context data can include computing device information such as the presence or absence of virus or spyware protection. Further, customer context data can include explicitly specified or inferred preferences regarding security as well as patience regarding updating constraints in exchange for additional security. General context data can include time, date, day of the week, season, or location, among others. In one instance, the context acquisition component 302 can query one or more databases to acquire context data.

The constraint prediction component 304 is operable to determine, infer or predict suggested spending constraints. High-level security involves significant spending constraints such as restricting purchases to a single merchant, limiting the amount spent, and the validity period. However, these constraints are an inconvenience for customers as their purchase power is inhibited, and they may need to frequently update a current virtual card are acquire a new card. Suggested spending constraints seek to balance security and customer convenience associated with virtual cards.

Context data can be utilized as a basis to suggest constraints. For example, the number and degree of constraints can be dictated by the security risk posed by a merchant and user computing device as well as user preferences. Per one aspect, the constraint prediction component 304 can implement and invoke a machine learning model to suggest spending constraints. In one instance, the machine learning model can be a supervised model. The model can be trained and tuned with data that identifies the use of one or more constraints with respect to merchant risk, user computing device risk, and user preferences. Other context data can also be a factor, such as time of day or day of the week. After the machine learning model is trained and tuned, the model can be invoked for a particular customer and merchant. The machine learning model can then seek to optimize the balance of security and convenience and output one or more constraints, including a degree of constraint (e.g., merchant, time, amount). The constraints can then be suggested to a user for consent, along with a recommendation to transition to a virtual card. The machine learning model can be updated to reflect changes in a security profile for a merchant and changes made to constraints by a user to improve the model's predictive power over time.

The financial interface component 306 is operable to enable interaction between the acquisition component 230 and a financial institution. For example, the financial interface component 306 can employ an application programming interface provided by a bank to request and acquire a virtual card, including a number, security code, and expiration date. Furthermore, the financial interface component 306 can communicate one or more constraints as determined or inferred by the constraint prediction component 304.

Returning to FIG. 2, the update component 240 is operable to update a customer's payment method for a merchant with a virtual card obtained by the acquisition component 230. The update component 240 can comprise or invoke a script or sequence of executable instructions that navigate a merchant's website to add a virtual card as a payment method. The script can first connect to a merchant's website. A customer may need to enter login credentials to permit access to the customer's account. Otherwise, addition of the virtual card can be completely automatic. The script can remove a primary payment method and replace the payment method with the virtual card. Stated differently, the script can swap the payment method to the virtual card. Each merchant can have a different mechanism for updating payment information. Accordingly, the update component 240 can locate the appropriate script for a merchant before triggering execution.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components can be combined into a single component to provide aggregate functionality. Communication between systems, components and/or sub-components can be accomplished following either a push or pull control model. The components can also interact with one or more other components not specifically described herein for the sake of brevity but known by those of skill in the art.

Various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, among others, can automate certain mechanisms or processes performed, thereby making portions of the systems and methods more adaptive as well as efficient and intelligent. By way of example, and not limitation, virtual card system 120 can employ such mechanisms to identify spending constraints for a virtual card as well as to determine when to trigger action to generate a virtual card.

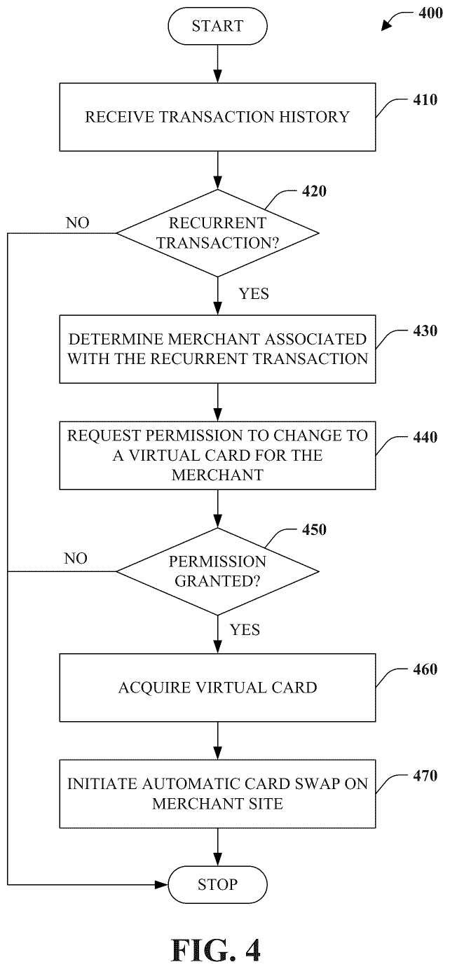

In view of the example systems described above, methods that can be implemented in accordance with the disclosed subject matter will be better appreciated with reference to flow chart diagrams of FIGS. 4-8. While for purposes of simplicity of explanation, the methods are shown and described as a series of blocks, it is to be understood and appreciated that the disclosed subject matter is not limited by the order of the blocks, as some blocks can occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

Turning attention to FIG. 4, a method 400 of transitioning to a virtual card is illustrated. The method 400 can be implemented and performed by the virtual card system 120.

At reference numeral 410, a customer's transaction history is received, retrieved, or otherwise obtained or acquired. The transaction history captures purchases made by a customer using a particular payment mechanism such as a traditional credit or debit card. For each transaction, the history can identify the date of purchase and the merchant, among other things. In one instance, a financial institution server can be queried to acquire the transaction history of the financial institution's customer.

At numeral 420, a determination is made as to whether or not a recurrent transaction exists. The transaction history can be analyzed to determine whether the customer has transacted with a merchant repeatedly. More specifically, a recurrent transaction can be configured in terms of frequency and time. A recurrent transaction can correspond to a monthly subscription purchase in one instance. Alternatively, a recurrent transaction can be said to exist when a user transacts with a merchant more than twice a month. If a recurrent transaction is not detected in the transaction history (“NO”), the method 400 can terminate. If a recurrent transaction is detected (“YES”), the method can proceed at 430.

At reference numeral 430, a merchant associated with the recurrent transaction is determined. For example, a transaction can be analyzed, and the merchant name can be extracted. Other information can also be determined, such as the website address of the merchant.

At numeral 440, permission is requested to change the payment method to a virtual card for a merchant. An alert or notification can be generated and displayed to a user in a browser. Other communications can also be used, including email and text message, among others. The alert can identify the merchant and provide a mechanism for a user to approve or deny the payment method change. Additional information can be provided or made available concerning spending constraints associated with a virtual card.

At reference numeral 450, a determination is made as to whether or not permission was granted to transition to a virtual card for future transactions with a particular merchant. Information regarding permission can be received utilizing a mechanism provided with the request. For example, the permission request can include buttons that, when selected by a customer, returns whether permission is granted or denied. The method terminates if permission is not granted but rather is denied (“NO”). If permission is granted (“YES”), the method continues at numeral 460.

At numeral 460, a virtual card is acquired. The virtual card comprises similar information captured on a conventional physical card, such as a card number, security code, and expiration date. The virtual card information can be requested from a financial institution such as a bank. For example, an application programming interface can be employed to request virtual card information from the financial institution and any spending constraints. The financial institution can generate a virtual card tied to the customer's account and return the information.

At reference numeral 470, an automatic card swap can be initiated on a merchant website. In essence, the primary payment method can be updated to be the virtual card rather than a conventional card. A script or program code associated with the merchant can be located and executed to accomplish this swap. The script can direct a web browser to open the merchant's site and perform actions required to replace any current primary payment method with the virtual card. In one instance, the customer may be required to provide login credentials before the swap occurs.

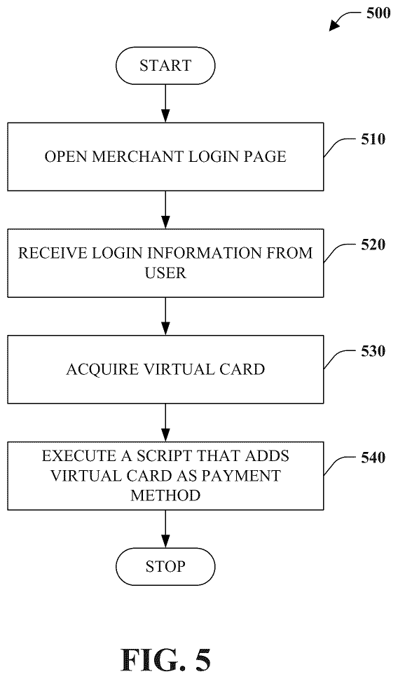

FIG. 5 depicts a method 500 of adding a virtual card to an online merchant store. The method 500 can be executed by the virtual card system 120 and, more particularly, the acquisition component 230 and the update component 240.

At reference numeral 510, a merchant login page is opened. The login page can be identified for the merchant. Subsequently, a browser can be instructed to navigate to and open the page.

At numeral 520, the login information is received from a customer. The login information can be entered into the corresponding locations on the login page. If the merchant employs dual-factor authentication, a user can also enter a code or the like provided by the merchant through a customer's mobile phone.

At numeral 530, a virtual card is received, retrieved, or otherwise obtained or acquired. The virtual card can be a non-physical card with a number, security code, and expiration date for online purchases. The virtual card can further include one or more spending constraints. In one instance, an application programming interface provided by a financial institution can be employed to request and acquire a virtual card, which can be linked to the customer's actual card or account.

At reference numeral 540, execution of a script is triggered or initiated. The script or executable program instruction can navigate the merchant's website and add the virtual card as a payment method. In one instance, the virtual card replaces a current primary payment method. In other words, the primary payment method can be swapped to the virtual card. The script can be merchant site-specific. As such, a corresponding script may need to be located and retrieved before triggering execution.

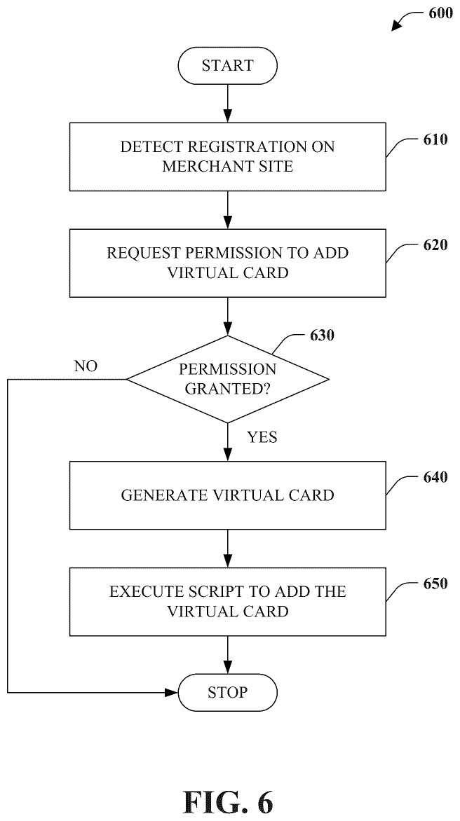

FIG. 6 is a flow chart diagram of a method 600 of adding a virtual card to an online merchant account. The method 600 can be implemented and executed by the virtual card system 120.

At reference numeral 610, registration on a merchant site is detected. Merchants encourage registration for online purchases with discounts, promotions, or other features unavailable to guests. Registration can involve providing an email address, user name, and password, among other things. User interaction with a browser can be monitored and analyzed to detect user registration. For example, a web browser extension can be employed to detect, infer, or predict that a user is in the process of registering with a merchant through the merchant's website. In one instance, registration features from particular sites can be known or learned such that when the web browser identifies such features, registration can be determined. Additionally, or alternatively, website registration processes can share similar features that can be exploited to determine registration. For example, registration processes typically use the term “register,” or variations thereof, and provide text boxes to provide a user name and password.

At numeral 620, permission can be requested to add a virtual card in conjunction with registration. An alert or notification can be presented that requests permission. For example, the alert or notification can be presented by a web browser overlaid on a web page as a pop-up in which permission can be granted or denied by clicking a corresponding button.

At reference numeral 630, a determination is made as to whether or not permission has been granted. This determination can be made based on a response or lack of response to a request for permission provided in an alert or notification. If permission is denied or no response is received (“NO”), the method 600 terminates. By contrast, if permission is granted (“YES”), the method 600 proceeds at numeral 640.

At numeral 640, a virtual card is generated or otherwise received or acquired. In accordance with one aspect, an application programming interface provided by a financial institution can be employed to request and receive a virtual card associated with a customer's account. The virtual card can include a number, security code, and expiration date linked to a customer's account to facilitate secure transactions. Further, a number of spending constraints can be associated with the virtual card, such as limiting spending to a specific merchant during particular times, and up to a preset limit.

At reference numeral 650, execution of a script or computer program comprising executable instructions can be triggered or initiated. More specifically, a script can be located that corresponds to a particular merchant's online experience. Executing the script can cause navigation of a merchant website to a webpage associated with payment. Once there, the primary payment method can be set as the virtual card. Purchases on the website can then be paid with the virtual card instead of a conventional credit or debit card. In this instance, a swap is not needed since the virtual card is set as the payment method during registration. Nevertheless, the virtual card may need to be replaced later for assorted reasons (e.g., expiration, fraud).

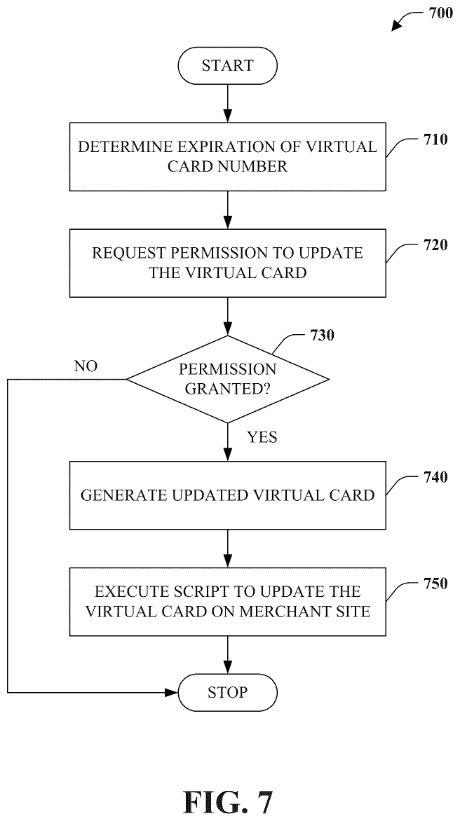

FIG. 7 illustrates a flow chart diagram of a method 700 of updating a virtual card. The method 700 can be implemented and executed by the virtual card system 120 of FIGS. 1 and 2.

At reference numeral 710, a determination is made that a virtual card has expired or will expire shortly. Information regarding a virtual card can be stored in a database in one implementation. Accordingly, determining whether the virtual card has or will expire shortly can comprise querying the database for the expiration date and comparing the expiration date to the current date. Alternatively, a script can be executed that navigates to the virtual card stored on a merchant website, acquires the expiration date, and compares the expiration date to the current date. Regardless of implementation, the fact that a virtual card has expired or will expire soon can be determined. Further, other conditions or constraints that affect purchase ability can also be evaluated, such as whether a spending limit has been hit or potential fraud is suspected based on attempted use at various merchants when the virtual card is limited to a single merchant.

At numeral 720, permission is requested to update the virtual card. For example, a browser extension can generate an alert or notification that requests permission from a customer. Alternatively, an email or text message can be sent to the customer requesting permission. In one instance, two options can be provided for selection: grant or deny.

At reference numeral 730, a determination is made concerning whether permission has been granted or denied by a customer. A response to the request for permission can be analyzed and used to make the determination. This response can be received or retrieved and utilized as a basis for further processing. If permission is not granted (“NO”), the method 700 can terminate. If permission is granted (“YES”), the method 700 can continue at numeral 740.

At numeral 740, an updated virtual card can be generated or otherwise acquired. In one instance, an updated virtual card can be a new virtual card (e.g., new number, security code, expiration date, spending constraints). Alternatively, an updated card can be substantially the same virtual card with a changed feature. For example, the virtual card can comprise the same number and security code but a different expiration date. In one implementation, the application programming interface provided by a financial institution can be utilized to trigger generation or acquisition of an updated virtual card.

At reference numeral 750, execution of a script or program can be triggered to update the virtual card on a merchant site. The script can navigate to a login page and request a customer provide login credentials to enable further execution. After successful login with the credentials, the script can navigate to a payment portion of the website and replace a current payment method with the updated virtual card. For example, an expired virtual card can be replaced with a new valid virtual card.

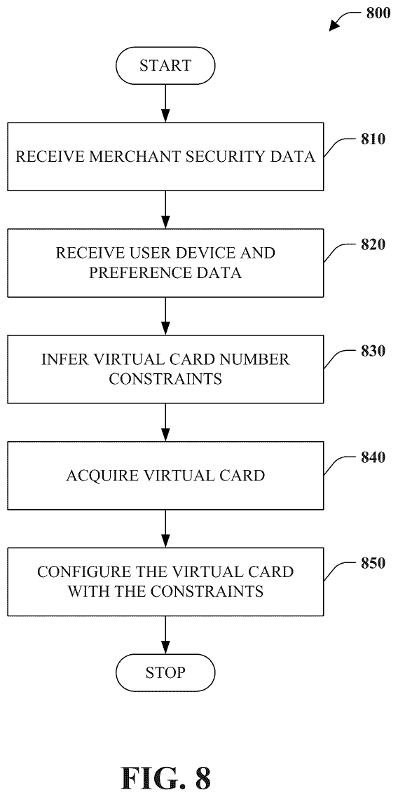

FIG. 8 is a flow chart diagram of a method 800 of configuring virtual card spending constraints. The method 800 can be implemented and performed by the virtual card system 120 and, more particularly, the acquisition component 230.

At reference numeral 810, merchant security data is received, retrieved, or otherwise obtained or acquired. Merchant security data can be any data or information utilized to determine a merchant's security risk. For example, the security data can correspond to historical information regarding security breaches or a lack of breaches. Further, the security data can concern the architecture of a merchant website to assess whether or not any vulnerabilities exist in how the website and underlying code operate. In one instance, security data can be utilized to compute a security score for an online merchant store.

At numeral 820, user device and preference data are received, retrieved, or otherwise obtained or acquired. User device data corresponds to computing device capabilities and security. For instance, the user device data can identify the browser, existence or absence of virus and spyware protection, type of protection, and history of security breaches, among other things. The user preference data can concern customer preferences regarding spending constraints. For example, a preference can be for no virtual card spending limit less than an account available balance or that there should be such a virtual card spending limit. Another preference can concern whether or not the card should be limited to use with a particular merchant or set of merchants. Yet another preference can concern a length of time prior to expiration of the virtual card. Customers can specify a particular preference, including no preference regarding various scenarios.

At reference numeral 830, virtual card constraints or parameters are inferred. An attempt is made to identify virtual card spending constraints that balance merchant risk and customer device risk and preferences. Security can be enhanced by specifying substantial spending constraints. However, customers will appreciate payment freedom. A balance can be sought regarding spending constraints that account for merchant and user device security risks and preferences. Although not limited thereto, in accordance with one embodiment, a machine learning model can be employed for this purpose. The machine learning model can seek to optimize security given user preferences. The machine learning model can output suggested constraints for a virtual card. For example, the constraints can include limiting spending to a single merchant, establishing a maximum purchase amount, and setting an expiration date of one year.

At reference numeral 840, a virtual card is received, retrieved, or otherwise obtained or acquired. For example, an application programming interface can be employed to acquire the virtual card number from a financial institution linked to a customer account. Concurrently or subsequently, the virtual card can be configured to include the suggested constraints at reference 850.

Aspects of the subject disclosure have been disclosed and described herein with respect to a web browser and a browser extension. Alternate embodiments are also possible. Consider a mobile banking application, for example. The mobile banking application can access transaction history and detect recurrent merchant transactions. In respect, permission can be requested within the mobile banking application to provision a virtual card for a merchant with whom the customer has recurrent transactions. In response to granted permission, a virtual card can be generated. In one instance, the mobile banking application can trigger opening a browser to the merchant's website, navigating to the payment portion of the website, and updating the payment method to be the virtual card. Alternatively, the mobile banking application can set a flag or the like that can be checked by a browser extension. When a browser is subsequently opened, the browser extension can check if the flag is set and, if so, initiate navigation to the merchant website and add the virtual card as the primary payment method.

The subject disclosure pertains to the technical problem of virtual cards and provisioning virtual cards for online merchant purchases. The technical solution includes analyzing merchant transactions or user actions associated with a merchant website for a trigger condition. Further, virtual card constraints can be analyzed to determine an optimal set of constraints that balances security and user preferences. A virtual card with a set of constraints can be acquired from a financial institution and a script executed in response to the trigger condition to navigate a merchant website to update the primary payment method to be the virtual card automatically.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component can be but is not limited to a process running on a processor, a processor, an object, an instance, an executable, a thread of execution, a program, and/or a computer. By way of illustration, both an application running on a computer and the computer can be a component. One or more components can reside within a process and/or thread of execution, and a component can be localized on one computer and/or distributed between two or more computers.

As used herein, the term “infer” or “inference” refer to the process of reasoning about or inferring states of a system, a component, an environment, or a user from one or more observations captured by way of events or data, among other things. Inference can be employed to identify a context or an action or can be used to generate a probability distribution over states, for example. An inference can be probabilistic. For example, computation of a probability distribution over states of interest can be based on a consideration of data or events. Inference can also refer to techniques employed for composing higher-level events from a set of events or data. Such inference can result in the construction of new events or new actions from a set of observed events or stored event data, whether or not the events are correlated in close temporal proximity, and whether the events and data come from one or several events and data sources.

The conjunction “or” as used in this description and appended claims is intended to mean an inclusive “or” rather than an exclusive “or,” unless otherwise specified or clear from the context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the preceding instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

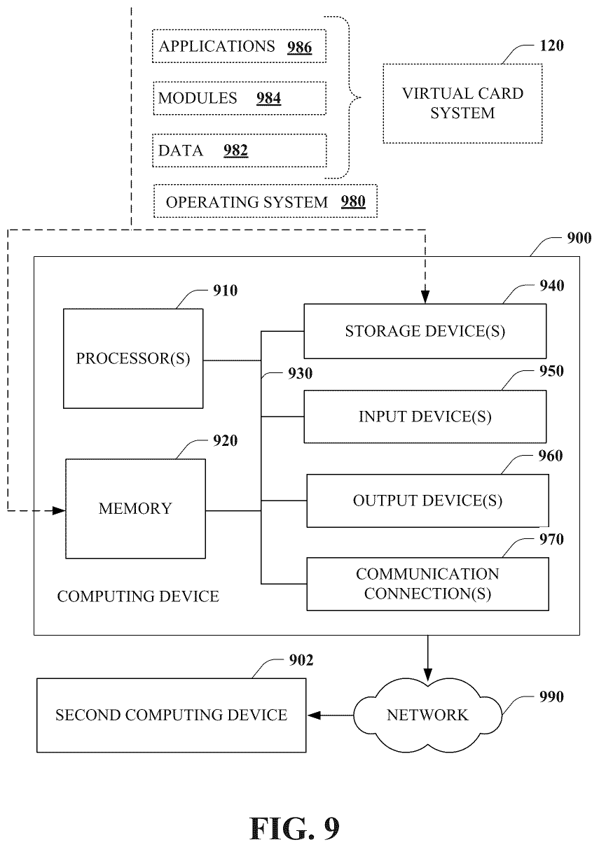

To provide a context for the disclosed subject matter, FIG. 9, as well as the following discussion, are intended to provide a brief, general description of a suitable environment in which various aspects of the disclosed subject matter can be implemented. However, the suitable environment is solely an example and is not intended to suggest any limitation on scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices linked through a communications network. However, some, if not all aspects, of the disclosed subject matter can be practiced on stand-alone computers. In a distributed computing environment, program modules can be located in one or both of local and remote memory devices.

With reference to FIG. 9, illustrated is an example computing device 900 (e.g., desktop, laptop, tablet, watch, server, hand-held, programmable consumer or industrial electronics, set-top box, game system, compute node, . . . ). The computing device 900 includes one or more processor(s) 910, memory 920, system bus 930, storage device(s) 940, input device(s) 950, output device(s) 960, and communications connection(s) 970. The system bus 930 communicatively couples at least the above system constituents. However, the computing device 900, in its simplest form, can include one or more processors 910 coupled to memory 920, wherein the one or more processors 910 execute various computer-executable actions, instructions, and or components stored in the memory 920.

The processor(s) 910 can be implemented with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. The processor(s) 910 can also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 910 can be a graphics processor unit (GPU) that performs calculations concerning digital image processing and computer graphics.

The computing device 900 can include or otherwise interact with a variety of computer-readable media to facilitate control of the computing device to implement one or more aspects of the disclosed subject matter. The computer-readable media can be any available media accessible to the computing device 900 and includes volatile and non-volatile media, and removable and non-removable media. Computer-readable media can comprise two distinct and mutually exclusive types: storage media and communication media.

Storage media includes volatile and non-volatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid-state devices (e.g., solid-state drive (SSD), flash memory drive (e.g., card, stick, key drive . . . ) . . . ), or any other like mediums that store, as opposed to transmit or communicate, the desired information accessible by the computing device 900. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 920 and storage device(s) 940 are examples of computer-readable storage media. Depending on the configuration and type of computing device, the memory 920 can be volatile (e.g., random access memory (RAM)), non-volatile (e.g., read only memory (ROM), flash memory . . . ), or some combination of the two. By way of example, the basic input/output system (BIOS), including basic routines to transfer information between elements within the computing device 900, such as during start-up, can be stored in non-volatile memory, while volatile memory can act as external cache memory to facilitate processing by the processor(s) 910, among other things.

The storage device(s) 940 include removable/non-removable, volatile/non-volatile storage media for storage of vast amounts of data relative to the memory 920. For example, storage device(s) 940 include, but are not limited to, one or more devices such as a magnetic or optical disk drive, floppy disk drive, flash memory, solid-state drive, or memory stick.

Memory 920 and storage device(s) 940 can include, or have stored therein, operating system 980, one or more applications 986, one or more program modules 984, and data 982. The operating system 980 acts to control and allocate resources of the computing device 900. Applications 986 include one or both of system and application software and can exploit management of resources by the operating system 980 through program modules 984 and data 982 stored in the memory 920 and/or storage device(s) 940 to perform one or more actions. Accordingly, applications 986 can turn a general-purpose computer 900 into a specialized machine in accordance with the logic provided thereby.

All or portions of the disclosed subject matter can be implemented using standard programming and/or engineering techniques to produce software, firmware, hardware, or any combination thereof to control the computing device 900 to realize the disclosed functionality. By way of example and not limitation, all, or portions of the virtual card system 120 can be, or form part of, the application 986, and include one or more modules 984 and data 982 stored in memory and/or storage device(s) 940 whose functionality can be realized when executed by one or more processor(s) 910.

In accordance with one particular embodiment, the processor(s) 910 can correspond to a system on a chip (SOC) or like architecture including, or in other words integrating, both hardware and software on a single integrated circuit substrate. Here, the processor(s) 910 can include one or more processors as well as memory at least similar to the processor(s) 910 and memory 920, among other things. Conventional processors include a minimal amount of hardware and software and rely extensively on external hardware and software. By contrast, a SOC implementation of a processor is more powerful, as it embeds hardware and software therein that enable particular functionality with minimal or no reliance on external hardware and software. For example, the virtual card system 120 and/or functionality associated therewith can be embedded within hardware in a SOC architecture.

The input device(s) 950 and output device(s) 960 can be communicatively coupled to the computing device 900. By way of example, the input device(s) 950 can include a pointing device (e.g., mouse, trackball, stylus, pen, touchpad, . . . ), keyboard, joystick, microphone, voice user interface system, camera, motion sensor, and a global positioning satellite (GPS) receiver and transmitter, among other things. The output device(s) 960, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 950 and output device(s) 960 can be connected to the computing device 900 by way of wired connection (e.g., bus), wireless connection (e.g., Wi-Fi, Bluetooth, . . . ), or a combination thereof.

The computing device 900 can also include communication connection(s) 970 to enable communication with at least a second computing device 902 utilizing a network 990. The communication connection(s) 970 can include wired or wireless communication mechanisms to support network communication. The network 990 can correspond to a local area network (LAN) or a wide area network (WAN) such as the internet. In one instance, the computing device 900 can correspond to a user computing device that executes the virtual card system 120 as a browser extension. The second computing device 902 can be a financial institution server for acquiring virtual cards. Alternatively, the second computing device 902 can comprise a web server that hosts a merchant website for which the payment method is set to the virtual card.

What has been described above includes examples of aspects of the claimed subject matter. It is, of course, not possible to describe every conceivable combination of components or methodologies for purposes of describing the claimed subject matter. However, one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A virtual card provisioning system, comprising:
a processor coupled to a memory that includes instructions that, when executed by the processor, cause the processor to:
detect a recurrent transaction with a merchant by a customer online based on analysis of transaction history of the customer from a financial institution;
request permission from a customer to provision a virtual card for payment of a merchant online through a web browser in response to detection of the recurrent transaction;
request the virtual card for the customer from the financial institution in response to receipt of granted permission, wherein the virtual card is linked to an account of the customer at the financial institution;
locate a browser script associated with the merchant; and
initiate execution of the browser script that directs a customer to a login webpage of a merchant website and, after successful login, navigates to a payment webpage of the merchant website and automatically sets the virtual card as the primary payment method on the merchant website.

2. The system of claim 1, further comprising instructions that cause the processor, during browser script execution, to remove a prior customer payment method for the website.

3. The system of claim 1, further comprising instructions that cause the processor to:
automatically infer a spending constraint that reduces likelihood of fraud based on context data considering the merchant and the customer; and
request the virtual card be configured with the spending constraint.

4. The system of claim 3, wherein infer the spending constraint further comprises invoking a machine learning model to infer the spending constraint.

5. The system of claim 3, wherein the spending constraint limits spending to transactions with the merchant.

6. The system of claim 3, further comprising instructions that cause the processor to:
determine that the virtual card is invalid based on a spending constraint that specifies expiration after a predetermined time or number of transactions; and
request the permission in response to a determination that the virtual card is invalid.

7. A method, comprising:
executing, on a processor, instructions that cause the processor to perform operations associated with provisioning a virtual card, the operations comprising
detecting a recurrent transaction with an online merchant in transaction history of a customer recorded by a financial institution;
soliciting permission from the customer to provision a virtual card for payment of an online merchant in response to the recurrent transaction;
requesting the virtual card for the customer from a financial institution in response to receipt of granted permission, wherein the virtual card is linked to an account of the customer at the financial institution;
searching for a browser script associated with the online merchant; and
triggering execution of the browser script that adds the virtual card as the primary payment method for a website of the online merchant after successful customer login to the website.

8. The method of claim 7, wherein the operations further comprise removing a prior customer payment method for the website with the processor, during browser script execution, to remove a prior customer payment method for the website.

9. The method of claim 7, wherein the operations further comprise:
inferring a virtual card constraint that reduces likelihood of fraud based on context data considering the merchant and the customer; and
requesting the virtual card be configured with the constraint.

10. The method of claim 9, wherein inferring the constraint further comprises executing a machine learning model to automatically infer the virtual card constraint.

11. The method of claim 7, wherein the operations further comprise adding a virtual card with a predetermined constraint as the primary payment method.

12. The method of claim 11, wherein the operations further comprise adding a virtual card limited to transactions with the online merchant as the predetermined constraint.

13. The method of claim 12, wherein the operations further comprise adding a virtual card that expires after a predetermined time or number of transactions as the predetermined constraint.

14. A computer-implemented method, comprising:
soliciting permission from a customer to provision a virtual card for payment of a merchant in response to detecting a trigger condition;
requesting the virtual card for the customer from a financial institution in response to receipt of granted permission, wherein the virtual card is linked to an account of the customer at the financial institution;
locating a browser script associated with the merchant from amongst a set of browser scripts for multiple merchants; and
triggering execution of a browser script that adds the virtual card as the primary payment method for a website of the merchant.

15. The method of claim 14, further comprising:
detecting, as the trigger condition, a recurrent transaction with a merchant by the customer from a transaction history of the customer; and
soliciting the permission from the customer in response to detection of the recurrent transaction.

16. The method of claim 14, further comprising:
detecting, as the trigger condition, registration on the website of the merchant; and
soliciting the permission in response to detecting registration.

17. The method of claim 15, further comprising swapping a current primary payment method with the virtual card during browser script execution.

18. The method of claim 15, further comprising directing the customer to a login page on the website of the merchant during browser script execution.

19. The method of claim 15, further comprising:
inferring a virtual card constraint that reduces a likelihood of fraud based on merchant security data and customer preference; and
requesting the virtual card be configured with the constraint.

20. The method of claim 19, wherein inferring the constraint further comprises invoking a machine learning model to determine the constraint automatically.
